(19) United States
(12) Patent Application Publication
(10) Pub. No.: US 2003/0204490 A1
(43) Pub. Date: Oct. 30, 2003

(54) Web-page collaboration system

(76) Inventor: Stephane Kasriel, San Francisco, CA (US)

Correspondence Address: ROBERT M. MCDERMOTT, ESQ., 1824 FEDERAL FARM ROAD, MONTROSS, VA, 22520, US

(21) Appl. No.: 10/255,768

(22) Filed: Sep. 26, 2002

Related U.S. Application Data
(60) Provisional application No. 60/375,166, filed on Apr. 24, 2002.

(51) Int. Cl. G06F 17/30

(52) U.S. Cl. 707/2; 715/512

(57) ABSTRACT

A collaborative development system is configured to allow the virtual appending of comments to a user-accessible document, without actually attaching the comments to the document. The collaborative development system allows authorized users to access the comments that are virtually appended to the document, in a manner similar to accessing comments that are actually attached to documents in a conventional collaborative development system. As used in a web-page development process, a conventional browser is used to access a released version of a web-page, and a browser band object is used to collect and display comments among developers of the web-page. The browser band object is synchronized to events in the browser, so that as each web-page is accessed, the comments that are associated with the selected page are accessed. The comments are stored independent of the web-page, and are accessible only to users of the collaborative development system. Changes to the web-page can be released without the overhead that is typically associated with the purging of comments in a conventional collaborative development system.

This Application claims the benefit of Provisional Patent Application No. 60/375,166, filed Apr. 24, 2002.

### BACKGROUND OF THE INVENTION

1. Field of the Invention

This invention relates to the field of computer systems, and in particular to a collaboration system that facilitates the ongoing development of web-pages.

2. Description of Related Art

Collaboration tools are commonly used to facilitate the coordination of activities in complex engineering development projects, and particularly in the field of software and program development. A developer provides an engineering document, such as a design specification, a flow-chart, a schematic, etc., for inclusion in a collaboration system. Other developers having access to the collaboration system can subsequently access the document and attach their comments to the document. The original developer, or other developers, can view these comments, add additional comments or remarks, and so on, thereby facilitating the flow of information that is often critical to a program's success. In a conventional collaboration system, the comments are typically appended to the document as hypertext entries. In a typical word processing system, for example, a highlighted footnote symbol appears at the point at which the comment has been added, and, depending upon the particular system, the added comments appear as footnotes to the page, or are displayed when the viewer clicks on the footnote symbol.

It is significant to note that a collaboration system, as the term is used in a development environment, and as used herein, maintains a single common copy of the document, to which all participants may append comments, make corrections, and so on. Some annotation systems exist that allow a user to attach a comment to a document and to forward a copy of the document with attached comment to another user. In such a system, the forwarded copy is distinct from the original document. If a third user annotates the original document and forwards it, this forwarded copy will be distinct from both the original document, as well as from the annotated document that was forwarded from the first user. If the second user responds to the first user by annotating the first forwarded copy and forwarding it, this forwarded copy is yet another distinct copy from the original and each of the other forwarded copies. This proliferation of different copies of a source document as comments or changes are made is contrary to the purpose of a collaboration system.

The documents that are submitted to the collaboration system generally include documents that will form part of the delivered product, such as user's guides, user interface pages, and the like, so that opinions can be gathered from members of a multi-discipline team. For example, marketing and sales professionals are provided the opportunity to review and comment upon the proposed content and format of the input and output pages that are presented to the user in the course of using the new product. In the development of web-pages for a web-site, for example, a webmaster or other computer professional will generally propose the content and format of each web-page, and the marketing professional will generally propose modifications that are intended to enhance the appeal or effectiveness of the page.

Prior to the release of the product, the documents that form part of the delivered product are purged of all the development comments, so that the released product includes only the information intended for the user of the product. A comment on a proposed web-page, for example, may say “Let's make the Purchase-button larger, and the Warranty-button smaller”, and it will be important that such a comment not be available for public viewing when the web-page is released for access on the web-page. After the release of a product, subsequent development of the user-accessible documents is effected by maintaining a development copy of the documents within the collaboration system, and comments are appended to these development copies. When a new version of the document is due to be released, the comments are purged from the development copy, and this purged document replaces the prior released version of the document.

To facilitate ongoing development and improvement of user documents in the context of a typical user's use of the document, a development environment is often created that mirrors the typical user environment. The development copies of the user documents are placed in this development environment, thereby allowing developers to experience a typical user encounter with these documents, and to add comments to the documents during this experience. In the context of a web-site development, for example, a development network is established that is isolated from the Internet, and development browsers are provided to browse the development network and to allow for the appending of comments to the currently browed web-page.

### BRIEF SUMMARY OF THE INVENTION

It is an object of this invention to allow for ongoing collaborative development of user-accessible documents. It is a further object of this invention to provide for this collaborative development in the context of the user environment. It is a further object of this invention to provide for this collaborative development with minimal development overhead. It is a further object of this invention to provide a collaborative development system that does not required the creation of a development environment that mirrors a user environment.

These objects and others are achieved by providing a collaborative development system that is configured to allow the virtual appending of comments to a user-accessible document, without actually attaching the comments to the document. The collaborative development system allows authorized users to access the comments that are virtually appended to the document, in a manner similar to accessing comments that are actually attached to documents in a conventional collaborative development system. As used in a web-page development process, a conventional browser is used to access a released version of a web-page, and a browser band object is used to collect and display comments among developers of the web-page. The browser band object is synchronized to events in the browser, so that as each web-page is accessed, the comments that are associated with the selected page are accessed. The comments are stored independent of the web-page, and are accessible only to users of the collaborative development system. Changes to the web-page can be released without the overhead that is typically associated with the purging of comments in a conventional collaborative development system.

### BRIEF DESCRIPTION OF THE DRAWINGS

The invention is explained in further detail, and by way of example, with reference to the accompanying drawings wherein:

FIG. 1 illustrates an example block diagram of a collaboration system for managing and coordinating annotations to a web-page in accordance with this invention.

FIG. 2 illustrates an example display of a collaborative web-page annotation system in accordance with this invention.

Throughout the drawings, the same reference numerals indicate similar or corresponding features or functions.

### DETAILED DESCRIPTION OF THE INVENTION

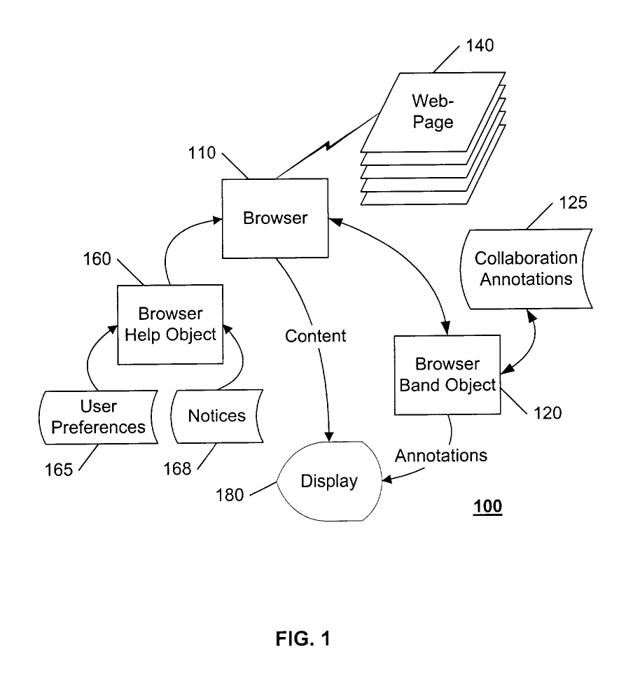

FIG. 1 illustrates an example block diagram of a collaboration system 100 for managing and coordinating annotations to a web-page 140 in accordance with this invention. Although the system of this invention may be used to facilitate collaboration on any document or sets of documents, it is particularly well suited for collaborative web-page development, and this exemplary paradigm is used herein to facilitate understanding.

FIG. 1 illustrates a conventional browser 110 that is used to access files 140 in a network. For ease of reference, an Internet browser 110 is illustrated that facilitates access to web-pages 140. The term ‘document’ is used herein to indicate the collection of items that form the displayed content of the web-page. That is, for example, a typical web-page is often hierarchically structured, wherein an upper-level file contains references to lower-level files. When the upper-level file is opened/executed, an instantiation and/or execution of each of the lower-level files, and potentially lower-lower-level files, is effected, so as to create a composite image, or ‘document’, that is commonly referred to as the web-page. As discussed further below, annotations may be associated with the document as an entity, or with specific parts of the document, such as a particular lower-level file, or with a superset that includes the document, such as a section of a web-site that contains the particular document, or the entire collection of documents at the web-site, and so on. Unless otherwise noted, references to a document or web-page include optional references to these subsets and supersets.

In accordance with a preferred embodiment of this invention, a browser band object 120 is used to effect the management and coordination of annotations 125 associated with one or more web-pages 140. The band object 120 is synchronized with access to each selected web-page, via the browser 110. The band object 120 notes which web-page the user is currently accessing, and concurrently accesses a database of annotations 125 to determine whether there are any annotations currently associated with the accessed web-page 140. If there are any annotations 125 associated with the accessed web-page 140, these annotations 125 are presented to the display 180 for concurrent rendering with the web-page 140. As used herein, the term database includes one or more storage elements that are configured to facilitate an efficient retrieval of information based on one or more search indices. The database may be distributed among a variety of hardware devices; it may be a central collection of data that is accessed by one or more servers; it may be a collection of files distributed among a variety of servers; it may be a single file on a networked PC; and so on.

Any of a variety of techniques may be applied to effect the concurrent rendering of annotations 125 with the web-page 140. In a typical browser 110, a band object 120 is allocated a region of the display space, typically a “side-bar” within the browser window, such as the “search” side-bar that appears within the browser window when a user selects the “search” option. In a straightforward embodiment of this invention, a list of annotations is displayed within the side-bar that is allocated to the band object 120. In a more complex embodiment, an annotation may be associated with a particular location or a particular object within the web-page 140, and may optionally be displayed as an overlay upon the displayed web-page, coincident with the associated location or object. The overlay may appear as a simple box, a note “bubble”, a “flag” item, or as an imitation of a physical entity, such as a Post-It® note, and so on. Also optionally, an icon may be displayed at the associated location or object, and the actual contents of the annotation are displayed upon selection of the icon. These and other techniques for concurrently displaying related information from two sources will be evident to one of ordinary skill in the art in view of this disclosure.

Preferably, each annotation 125 includes an address field that is configured to limit access to the annotation. When a user creates an annotation 125, the user is provided the option of identifying individuals, groups, and sub-groups for which the annotation 125 is intended. When another user accesses the web-page 140 that has this annotation attached, the band object 120 compares an identifier of this user to the address field to determine whether to display the annotation 140. Alternatively, the database that contains the annotations 125 can be configured to limit access to its contents based on the identifier of the user and the address field of each annotation 125. In a secure embodiment of this invention, the annotations 125 are encrypted, to prevent unauthorized disclosure.

Each annotation 125 also preferably includes one or more time fields that are configured to facilitate the initiation of other actions. For example, an annotation may have a “delivery” field, wherein a user specifies whether an addressee of the annotation is to be notified right away of the presence of the annotation, or whether the user and/or the addressee is to be notified of a lack of access or response to the annotation within a given time frame, and so on. In like manner, a “to-do” field may be provided that causes a notice to be posted on a scheduler, or calendar program, that is associated with the user and/or the addressee. These and other techniques for spawning other processes at particular times based on the contents of a time field in the annotation will be evident to one of ordinary skill in the art in view of this disclosure.

Also preferably, each annotation 125 may include a reference to ancillary information. For example, a user may annotate a document with: “I think the background should be blue; see attached marketing report on buyers' perceptions and biases.” Or, “This picture is drab; attached is a more lively photo for your consideration.” Conventional techniques, such as the use of hypertext, may be employed to effect this referencing to external material.

As noted in the Background to this invention, conventional techniques exist for concurrently displaying annotations that are associated with a document, but the known techniques include creating a copy of the original source document, and appending the annotations to this copy. In accordance with this invention, the annotations 125 that are associated with a web-page 140 are stored in a database that is substantially independent of the web-page 140. This segregation provides distinct benefits: the original source document 140 remains unaffected by the annotations; all annotations are referenced to the same source document 140; and, resources are not consumed by the generation of multiple copies of the source document 140.

Of particular note, in a collaborative development system, the engineering staff, marketing staff, support staff, etc. can address the actual product (the web-page 140) that is being developed or modified, without actually attaching their comments to the product, and without having to create a test environment. Because all annotations from all users refer to the original source documents, and not to copies of the source documents, the proliferation of spurious copies of the documents, and the confusion that typically results from such proliferation is avoided.

In some instances, a copy of the source document may be required. For example, if the web-page 140 dynamically changes, or is customized for particular applications or users, a developer may wish to take a snap-shot of the page at a particular point in time. In a preferred embodiment, the annotation 125 will be associated with the original source document, and will include a reference to the particular snap-shot of the page as an ancillary referenced item, as discussed above.

As noted above, an annotation may be associated to a group of documents. This group association may be explicitly identified by the user, or the collaboration system 100 may automatically provide this association. For example, a user may explicitly reference multiple documents in the annotation, as in “make page A look like page B”, or, “the colors on pages X, Y, and Z are too dark”, and so on. Or, the user may provide an annotation regarding a particular template, and the system automatically associates the annotation with each page that uses the template. In like manner, a web-site may be partitioned into sections, and an annotation may be associated with all of the documents within a section. These and other techniques for associating an annotation with multiple documents will be evident to one of ordinary skill in the art, in view of this disclosure.

Also illustrated in FIG. 1 is an optional browser helper object 160 that is configured to facilitate the implementation of user preferences 165.

In a typical browser environment, helper objects are always invoked when the browser is started, whereas a band object is invoked only if it had been invoked when the browser was last exited. Other default behavior may also be associated with the initiation of the browser.

To facilitate custom control of the collaboration system 100, the browser helper object 160 of this invention accesses the user preferences 165 and subsequently issues commands to the browser 110 to effect these preferences 165, independent of the default behavior of the browser 110. For example, a user may prefer that the band object 120 is always invoked, or never invoked, when the browser 110 is started, independent of whether the band object 120 had been invoked when the browser 110 was last exited. Similarly, the user may prefer that the band object 120 be invoked under certain circumstances, but not others. For example, the user may choose to invoke the band object 120 whenever the user is browsing a particular web-site, or web-page, and to disable the band object 120 whenever the user traverses to another web-site. Other customizing features will be evident to one of ordinary skill in the art in view of this disclosure, as will other techniques for enabling user preferences and customization.

Also illustrated are notices 168 that are optionally provided to facilitate alerting a user that an annotation has been received. For example, a notice 168 may effect a redirection of the user's “home” page to the web-page that contains a new annotation. Alternatively, the notice 168 may effect the display of a list of web-pages that contain new annotations, for the user's perusal and optional selection.

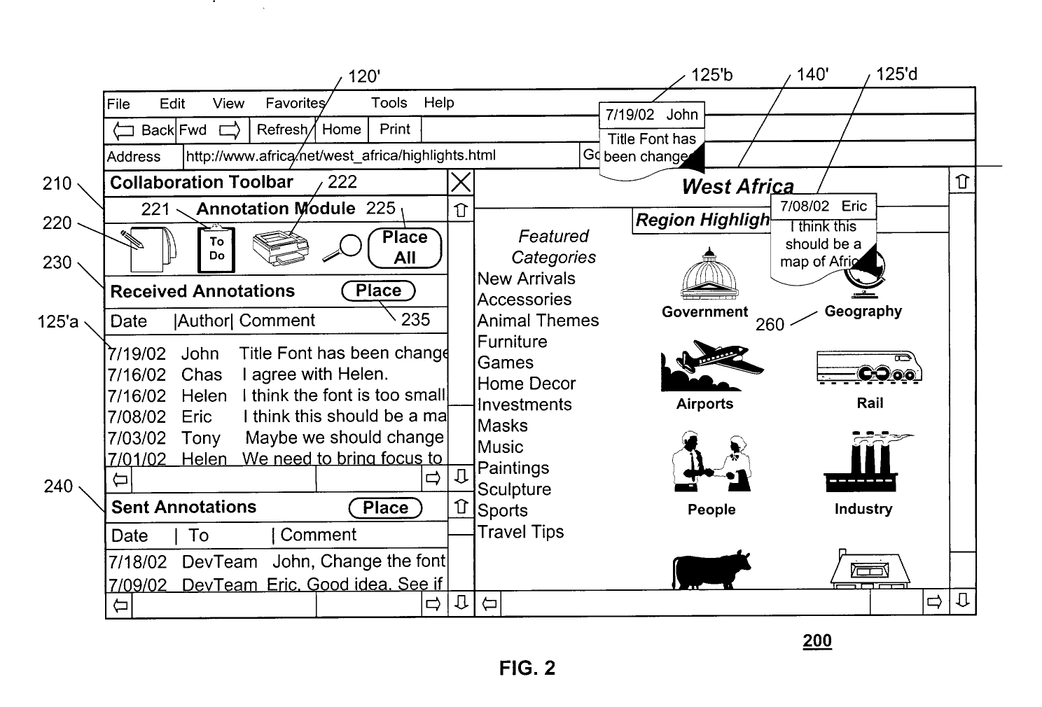

FIG. 2 illustrates an example display 200 of a web-page collaboration system in accordance with this invention. The display 200 is intended to represent a display of a web-page 140′ and browser band object 120′ via a conventional browser. (The appended prime (′) to a reference numeral indicates a screen display of the corresponding reference item of FIG. 1.) The example display of the band object 120′ includes a display of the annotation module 210 with icons 220-225 that represent typical tasks, such as creating 220 an annotation, managing 221 a “ToDo” list, printing 222, and so on. At 230, the received annotations are displayed, and at 240, the sent annotations are displayed.

When an annotation is created, via a selection of the icon 220, the creator of the icon is provided various options, one of which is the option to “place” the annotation upon the web page at a given location. When the annotation is received, the user is given the option of “placing” the annotation upon the web-page at the specified location, via activation of the ‘place’ button 235. Items 125′a and 125′b illustrate an unplaced and a placed annotation, respectively. In this example 125′b, the author/creator (John) of the annotation 125′ placed the comment at the title panel, and this position information was stored in a position field of the annotation. If a subsequent user desires to put the annotation 125′ “in context”, the user selects the annotation 125′a, then selects place 235, and the band object places the annotation 125′b at the location on the user's display of the web-page 140′ that corresponds to the stored position information. The user also has the option of placing all the annotations upon the web-page, via selection of the ‘place all’ button 225.

Preferably, users are provided the option of associating annotations to objects within the web-page. For example, the annotation 125′d may be associated with the “geography” object 260. By associating an annotation to an object, changes to the object will automatically cause appropriate changes to the annotation. If the geography object 260 is subsequently relocated, for example, the associated annotation 125′d will be relocated as well. If the object is deleted, the user is prompted for permission to also delete the associated annotation, or to associate the annotation to another item.

When the user selects the add-annotation button 220, the user is provided a window for entering text and for controlling delivery options for the annotation. In a preferred embodiment, for example, as discussed above, the user identifies the intended addressees, the delivery priority, and whether any subsequent actions should be taken or scheduled. For example, the user may select having one or more of the addressees notified directly that an annotation has been added, via e-mail or other alerting means. As discussed above, changes may be made to the manner in which an addressee's browser is initialized, to bring the annotated web-page to the addressee's attention in a timely manner. In like manner, the user may select that an action be scheduled, typically in the form of an entry into a “todo” list.

As also discussed above, the annotation may be associated with an object within the web-page, with the web-page itself, with the web-site that contains the page, and so on. That is, although the creator of the annotation may be at a particular page when the annotation is created, the creator can associate the annotation to the entire web-site, so that whenever another user accesses the web-site, the annotation will appear in the received-annotation section 230 of the band object. When the user indicates completion of the add-annotation task, the band object 120 of FIG. 1 stores the new annotation at the database of annotations 125, appropriately indexed to the associated web-page or web-site, or other file identifier. Thereafter, when another user accesses the associated page, site, or file, the band object 120 of the other user searches the database for annotations associated with the associated page, site, or file and addressed to this other user. If such annotations are found, they are displayed concurrent with the display of the web-page, as discussed above.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A collaboration system comprising:
a monitor component that monitors a user's access to a source document,
an annotation component, operably coupled to the monitor component, that is configured to facilitate a retrieval of one or more annotations associated with the source document from a database of annotations, based on the user's access to the source document, and
a display component, operably coupled to the annotation component, that is configured to facilitate a display of the annotations coincident with a display of the source document.

2. The collaboration system of claim 1, wherein
the retrieval of the one or more annotations is further based on an identification of the user.

3. The collaboration system of claim 1, wherein
the database of annotations also includes other annotations associated with other source documents.

4. The collaboration system of claim 3, wherein
the database of annotations is located at a server that is accessible to the user via an Internet connection.

5. The collaboration system of claim 1, wherein
the source document comprises a web page.

6. The collaboration system of claim 5, wherein
the annotation component is further configured to facilitate retrieval of one or more other annotations associated with a web site that is associated with the web page, and
the display component is further configured to facilitate display of the one or more other annotations.

7. The collaboration system of claim 1, wherein
the annotation component is further configured to obtain a new annotation associated with the source document from the user and to facilitate storage of the new annotation in the database of annotations for subsequent retrieval by one or more other users.

8. The collaboration system of claim 7, wherein
the new annotation includes a time field, and
the collaboration system further includes
a calendar component that is configured to schedule one or more events based on contents of the time field.

9. The collaboration system of claim 7, wherein
the new annotation includes an address field, and
the collaboration system further includes
a routing component that is configured to provide notification notices to one or more addressees identified in the address field.

10. The collaboration system of claim 6, wherein
the new annotation includes an identification of one or more attachments that are associated with the new annotation.

11. The collaboration system of claim 10, wherein
the one or more attachments include an image of at least a part of the source document.

12. The collaboration system of claim 1, wherein
the annotation component is further configured to facilitate modification, including deletion, of an annotation of the one or more annotations from the database.

13. The collaboration system of claim 1, wherein
the monitor component is further configured to monitor selection of a subset of the source document, and
the retrieval of the one or more annotations is further based on the selection of the subset of the source document.

14. The collaboration system of claim 1, wherein
the monitor component comprises a browser band object that monitors the user's access to the source document via a browser.

15. The collaboration system of claim 14, wherein
the browser band object also includes the annotation component.

16. The collaboration system of claim 15, further including
a browser help object that is configured to initialize the browser based on one or more user preferences.

17. The collaboration system of claim 15, further including
a browser help object that is configured to alert the user when a new annotation has been associated with the source document.

18. A method of facilitating communication of comments relating to a source document, the method comprising:
obtaining an identification of the source document, based on access by a user to the source document,
obtaining a comment from the user related to the source document,
storing the comment and the identification at a database that is configured to facilitate retrieval of the comment by one or more other users, via the identification of the source document.

19. The method of claim 18, wherein
the comment includes a time field, and
the method further includes
initiating a subsequent action, based on contents of the time field.

20. The method of claim 18, wherein
the comment includes an address field, and
the method further includes
providing a notification to one or more addressees identified in the address field.

21. The method of claim 18, wherein
the database is located at a server that is accessible via an Internet connection, and
storing the comment and the identification includes
transmitting the comment and the identification to the database via the Internet connection.

22. The method of claim 18, wherein
the source document comprises a web page that is accessible via an Internet connection, and
obtaining the identification of the source document includes
monitoring pages visited by the user via a browser that provides the Internet connection.

23. The method of claim 18, further including
determining a plurality of identifications of other documents to which the comment from the user is related, and
storing the plurality of identifications with the comment at the database, to facilitate retrieval of the comment via any of the plurality of identifications.

24. A method of facilitating communication of comments relating to a source document, the method comprising:
obtaining an identification of the source document, based on a user's access to the source document,
retrieving at least one annotation from a database of a plurality of annotations, based on the identification of the source document, and
displaying the at least one annotation coincident with a display of the source document.

25. The method of claim 24, wherein
the at least one annotation includes a placement parameter relative to the source document, and
displaying the at least one annotation coincident with the display of the source document is based on the placement parameter.

26. The method of claim 24, wherein
the at least one annotation includes an address field, and
retrieving the at least one annotation is further based on the address field and an identification of the user.

27. The method of claim 24, wherein
the database is located at a server that is accessible via an Internet connection, and
retrieving the at least one annotation includes
receiving the at least one annotation via the Internet connection.

28. The method of claim 24, wherein
the source document comprises a web page that is accessible via an Internet connection, and
obtaining the identification of the source document includes
monitoring pages visited by the user via a browser that provides the Internet connection.

29. The method of claim 28, wherein
monitoring the pages is effected via a band object that is associated with the browser.

30. The method of claim 24, further including
alerting the user of the at least one annotation.
